(19) United States
(12) Patent Application Publication
(10) Pub. No.: US 2008/0087442 A1
(43) Pub. Date: Apr. 17, 2008

(54) Protective Device for Horses' Hooves

(76) Inventors: Franck Cherel, Montreuil-Juigne (FR); Claude Bourget, Vertou (FR); Isabelle Bricaud Raimbault, Yzernay (FR); Jean-Pierre Raimbault, Yzernay (FR)

Correspondence Address: YOUNG & THOMPSON, 745 SOUTH 23RD STREET, 2ND FLOOR, ARLINGTON, VA, 22202, US

(21) Appl. No.: 10/577,525

(22) PCT Filed: Oct. 27, 2004
(86) PCT No.: PCT/FR04/02761

§ 371 Date: May 7, 2007

(30) Foreign Application Priority Data
Oct. 29, 2003 (FR) 0312663

(51) Int. Cl. A01L 5/00; A01L 7/02

(52) U.S. Cl. 168/12

(57) ABSTRACT

A device used to protect the hoof of a horse, replaces a horseshoe and takes the form of a sole (1) which is glued to the lower surface of the hoof, i.e. the surface that rests on the ground. The sole (1) is made from a low-density synthetic material. Moreover, at least one part of the sole includes at least two stacked layers (2, 3) of material having different hardness values. One of the layers (2) has a greater hardness value in order to withstand wear and abrasion, the layer forming the surface of the sole (1) that rests on the ground, while another layer (3) has a lower hardness value in order to form a shock absorbing and/or damping layer, the layer being intended to come into contact with the hoof. The assembly follows the natural deformations in the horny wall of the hoof.

The present invention relates to a device for the protection of a horse's hoof, having the form of a sole fixed by cementing to the lower surface, which bears on the ground, of the hoof and which is a substitute for a horseshoe.

For many years, horseshoes made of metal no longer give satisfaction. Thus, horseshoes are adapted to protect the hoof, in particular the horny wall of said hoof, this part corresponding to the part of the hoof adapted to bear against the ground. However, the hoof constitutes the equivalent of a nail on which the horse walks. Because it constitutes a nail, this hoof is subjected to regular growth. As a result, it is necessary to shod and unshod frequently horses in the case of racehorses to have shoes best adapted to the shape of a hoof. The repetition of these operations of shodding and unshodding, which requires each time the use of nails, gives rise to rapid damage of the horny wall of the hoof. Moreover, horseshoes are conventionally made of steel, aluminum or other metals. Because of this, shoes known today have a high weight which limits the speed and freedom of movement of the horse and which moreover offers a rigidity which prevents the absorption of shocks and is an obstacle to the mobility of the hoof, which gives rise to a certain number of pathologies such as tendonitis and microtraumatisms.

Developments which have taken place in the course of recent years have thus had the object, either to lighten horseshoes, particularly with the appearance of aluminum shoes, or to overcome the nailing operations by fixing such aluminum shoes by cementing.

To solve the pathologies observed in horses, it has also been proposed to insert, between the horseshoe and the lower surface of the hoof, a shock absorbing sole as shown in particular in the patent EP 1 095 562. Other examples of soles for horses are particularly described in the patents FR 2 575 033, U.S. Pat. No. 4,573,538, U.S. Pat. No. 6,082,462 and EP 0 823 209.

All the solutions examined up to the present have again numerous drawbacks connected to the fact that they do not take completely into consideration the anatomy of the horse's hoof, which requires maintaining the lower surface of the hoof sufficiently free to permit relative movement of the different elements constituting the hoof.

An object of the present invention is thus to provide a protective device for a horse's hoof of great lightness so as to permit a greater frequency and greater flexibility of the movements of the horse, which permits improving its performance.

Another object of the present invention is to provide a protective device for a horse's hoof whose design permits, by reason of its shock absorbing properties, to limit, even to overcome the pathologies such as tendonitis, observed in horses.

Another object of the present invention is to provide a device for the protection of a horse's hoof whose design permits deformation of the horny wall under pressure, not only in a horizontal direction but also in a vertical direction, engendered by movements of the horse, which also contributes to avoiding the various pathologies set forth above.

Another object of the present invention is to provide a protective device for a horse's hoof whose design permits avoiding damage to the hoof caused by frequent changes of shoes fixed by nails, by means of securement by cementing, which is non-destructive of the horny wall of the hoof.

Another object of the present invention is to provide a protective device for a horse's hoof whose design permits obtaining a product perfectly adapted to the shapes and dimensions of the horse's hoof to be thus equipped.

To this end, the invention has for its object a device for protecting a horse's hoof having the shape of a sole affixed by cementing to the lower surface that bears against the ground, of the hoof and which substitutes for a horseshoe, characterized in that said sole, made of a synthetic material of low density, is for at least a portion of said sole, constituted by the superposition of at least two layers of material of different hardnesses, one of the layers, of greater hardness to resist wear and abrasion, constituting the surface that bears on the ground of said sole, another layer, adapted to come into contact with the hoof, having lesser hardness to constitute a layer for damping and/or shock absorbing, the assembly permitting accommodating natural deformations of the horny wall of the hoof.

Thanks to the provision of the sole adapted to be a substitute for a horseshoe in a stratified form comprising, for at least a portion of the sole, at least two layers of different hardness, there results a lightweight product, resistant to wear and abrasion whilst having shock absorbing and flexibility characteristics which permit accommodating the natural deformations of the horny wall of the hoof.

The invention will be fairly understood from a reading of the following description of examples of embodiment, with reference to the accompanying drawings, in which:

FIG. 1 is a partial perspective view of a protective device according to the invention, positioned upside down and in which the layers have been shown transparent to illustrate their superposition;

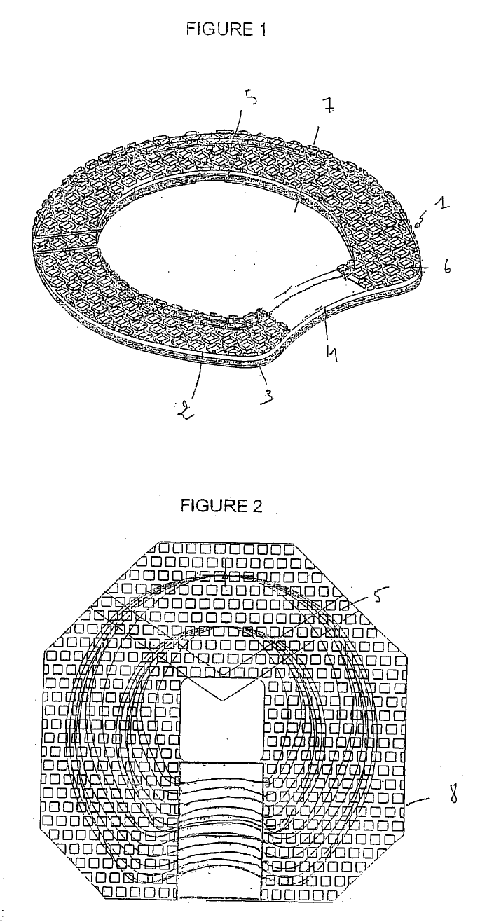

FIG. 2 is a top plan view of a blank serving for the production of the sole; and

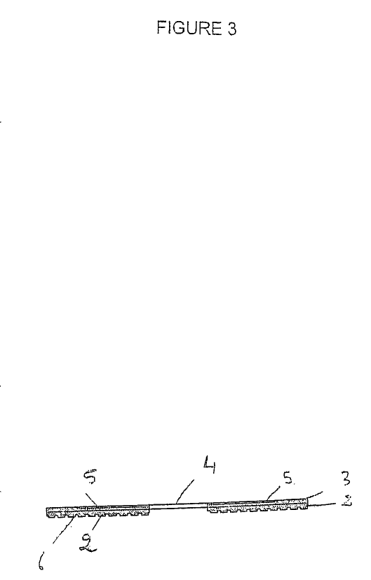

FIG. 3 is a cross-sectional view of the sole shown in FIG. 1.

As mentioned above, the protective device for a horse's hoof, according to the invention, has the form of a sole 1. This sole 1 is adapted to be fixed by cementing to the lower surface, which bears on the ground, of the hoof and to be a substitute for a horseshoe. As a result, the presence of a horseshoe is no longer necessary.

This sole 1 is made of a low density synthetic material. At least a portion of this sole 1 is present in the form of a stratification constituted by a superposition of at least two layers, 2, 3 of material of different hardnesses. One of these layers, shown at 2 in the drawings, constitutes the bearing surface against the ground of this sole 1. This layer has a greater hardness to resist wear and abrasion. Preferably, this lower layer 2 that bears against the ground, of the sole 1, has a hardness comprised within the range of Shore A40 to Shore D50.

Another layer 3 of the sole, adapted to come into contact with the hoof, has lesser hardness to constitute a damping and/or shock absorbing layer. This layer 3, called the upper layer, in contact with the hoof, is preferably in the form of an expanded foam microstructure. The presence of this foamed microstructure permits this layer on the one hand to constitute a surface for adherence of the cement, and on the other hand thus has a lower density permitting obtaining a sole of more reduced weight. Each layer 2, 3 is preferably made of an elastomeric material selected preferably from the group of compounds including polyurethanes.

To produce the sole 1, a blank 8 is produced in large numbers by molding, preferably by injection of the layers 2 and 3, one of the layers being preferably injected onto the surface of the other layer. In this case, the production takes place in two steps. A first layer is thus produced, then the second layer is injected onto the surface of the first layer. The sole could also be produced in an analogous manner by co-injection of said layers 2 and 3. It could also be envisaged to produce the layers in separated form and then to assemble them by means of a suitable binder.

This blank 8 is then cut out to be shaped and dimensioned so as to cover a plurality of sizes of the sole 1. Thus, as shown in FIG. 2, it is possible, from a same blank 8, to cut out from said blank a sole whose shapes and dimensions are a function of the desired size. FIG. 2 thus shows the different possibilities of production of the sole by cutting out the blank. There can thus be covered a large range of sizes of soles. The cutting out of this mass produced blank 8 can be carried out by punching, by cutting with a water jet, by laser cutting or by any other suitable means. The possibility of cutting out a blank 8 to obtain the sole 1 permits adapting it best to the morphological characteristics of each horse's hoof. There is thus obtained a tailor made sole.

In the illustrated examples, the sole 1 is present in the form of a structure open in its central portion whose peripheral external edge is shaped to follow the external contour of the hoof at least over a portion of this contour. The recess is represented at 7 in the drawings. The inner periphery of the sole delimiting this recess 7 is itself adapted to the interior shape of the hoof. In the illustrated examples, this sole 1 is a structure open in its central portion, and closed of general annular shape. Thus, this sole 1 has the shape of an arc of a circle in a manner like the shape of a conventional horseshoe, the free ends of this arc of the circle being adapted to be connected together to permit the closing of said structure. The portion 4 of the sole 1, which corresponds to the closure region of the sole and which is adapted to extend in line with the fork of the hoof, is made in the form of a single layer corresponding to the layer 2 that bears on the ground, of greater hardness, of said sole. This portion 4 of the sole, adapted to extend in line with the fork of the hoof, can be in the form of a separable portion at the time of applying the sole. This portion can however be preserved. It thus permits a deformation of the sole whilst maintaining this deformation within a predetermined range of deformation and thus gives a supplemental holding effect to the assembly of the sole. The sole can also be made in the form of a piece which is an open arc of a circle in a manner analogous to a conventional horseshoe.

This sole 1 also comprises, on its surface adapted to come into contact with the hoof, at least two grooves 5 that converge. Each groove 5 serves for the reception of a securement member called a pinch in the field of horses. This pinch, resembling a pincher with two resiliently deformable legs, serves for the securement of the sole 1 to the wall of the hoof. Such a pinch is already known in the art in coaction with a horseshoe.

To facilitate the adherence of such a sole to the ground, the layer 2 that bears on the ground of said sole 1 is shaped in the form of cramps 6 improving the adherence of said sole to the ground. Of course, the cramps 6 can have diverse and varied shapes.

Once the sole 1 is cut out from the blank 8, this sole 1 is fixed to the hoof by cementing, which renders the emplacement of this sole extremely easy. Generally, the sole 1 is fixed to the hoof by an acrylic cement, preferably bi-component.

1. Device for protection of a horse's hoof, having the shape of a sole (1) fixed by cementing to the lower surface, which bears on the ground, of the hoof and substituting for a horseshoe,
characterized in that said sole (1), made from a low density synthetic material, is, for at least a portion of the sole, constituted by the superposition of at least two layers (2, 3) of material of different hardnesses, one (2) of the layers, of a greater hardness to resist wear and abrasion, constituting the surface of said sole (1) that bears on the ground, another layer (3), adapted to come into contact with the hoof, having a lesser hardness to constitute a damping and/or shock absorbing layer, the assembly permitting accommodating the natural deformations of the horny wall of the hoof.

2. Device according to claim 1, characterized in that each layer (2, 3) is made of an elastomeric material selected preferably from the group of components including the polyurethanes.

3. Device according to claim 1,
characterized in that the layers (2, 3) are made by molding, preferably by injection, one of the layers being preferably injected onto the surface of the other layer.

4. Device according claim 1,
characterized in that the lower layer (2) that bears on the ground of the sole (1) has a hardness comprised within the range of Shore A40 to Shore D50.

5. Device according to claim 1,
characterized in that the so-called upper layer (3), in contact with the hoof, is made in the form of an expanded foam microstructure.

6. Device according to claim 1,
characterized in that the sole (1) is obtained by cutting out a mass-produced blank (8) and shaped so as to over a plurality of sizes of the sole (1).

7. Device according to claim 1,
characterized in that the sole (1) is in the form of an open structure whose peripheral external edge is shaped to follow the external contour of the hoof at least over a portion of this contour.

8. Device according to claim 1,
characterized in that the sole (1) is a closed structure, hollow, of a generally annular shape, the portion (4) of the sole (1) adapted to be disposed in line with the fork of the hoof, being in the form of a single layer corresponding to the layer (2) that bears on the ground of greater hardness of said sole.

9. Device according to claim 1,
characterized in that the sole (1) is a closed structure hollow in its central portion, the portion (4) of the sole (1), that is in line with the fork of the hoof, being made in the form of a portion that is separable at the time of applying said sole.

10. Device according to claim 1,
characterized in that the sole (1) comprises, on its surface adapted to come into contact with the hoof, at least two grooves (5) that converge, each groove serving for the recess of a securement member of the pinch type.

11. Device according to claim 1,
characterized in that the layer (2) that bears on the ground of said sole (1) is configured in the form of cramps (6) improving the adherence of said sole to the ground.
